(19) United States
(12) Patent Application Publication
(10) Pub. No.: US 2026/0189092 A1
(43) Pub. Date: Jul. 2, 2026

(54) POWER-GENERATING COMPONENT OF AN ELECTRIC MACHINE AND WAVE WINDING

(71) Applicant: ZF FRIEDRICHSHAFEN AG, Friedrichshafen (DE)

(72) Inventors: Kai MEHLSTÄUBL, Neidlingen (DE); Robin MICHELBERGER, Schweinfurt (DE); Matthias EBERT, Himmelstadt (DE)

(21) Appl. No.: 18/866,207

(22) PCT Filed: May 15, 2023
(86) PCT No.: PCT/EP2023/062903

§ 371 Date: Nov. 15, 2024

(30) Foreign Application Priority Data
May 17, 2022 (DE) 10 2022 204 816.4

(51) Int. Cl. H02K 3/28; H02K 1/16; H02K 3/12

(52) U.S. Cl. CPC H02K 3/28; H02K 1/16; H02K 3/12

(57) ABSTRACT

A power-generating component of an electric machine having an annular lamination stack with a plurality of radially arranged slots and a wave winding with at least a first continuous conductor, a second continuous conductor, and a third continuous conductor, each guided in a plurality of revolutions through adjacent slots and which form a composite conductor. The composite conductor has a slot jump in which the first, second, and the third conductors, respectively, span an equal number of slots and in which there is a layer change. The composite conductor further has at least one slot jump change as a result of which the arrangement of the first, second, and third conductors relative to one another are swapped after the slot jump change. At least one slot jump change is provided within every revolution of the composite conductor.

### CROSS REFERENCE TO RELATED APPLICATIONS

This is a U.S. national stage of Application No. PCT/EP 2023/062903 filed May 15, 2023. Priority is claimed on German Application No. DE 10 2022 204 816.4 filed May 17, 2022 the content of which is incorporated herein by reference.

### BACKGROUND OF THE INVENTION

### 1. Field of the Invention

The disclosure is directed to a power-generating component of an electric machine, such as a rotor or a stator of an electric motor. The power-generating component comprises an annular lamination stack with a plurality of radially arranged slots and a wave winding with at least a first continuous conductor, a second continuous conductor and a third continuous conductor which are guided in each instance in a plurality of revolutions through adjacent slots and which are connected in parallel or in series and form a composite conductor. The composite conductor has a slot jump in which the first conductor, the second conductor and the third conductor, respectively, span an equal number of slots and in which there is a layer change. Further, the composite conductor has at least one slot jump change in which the first conductor, the second conductor and the third conductor span different numbers of slots such that the arrangement of the first conductor, the second conductor and the third conductor relative to one another is swapped after the slot jump change.

### 2. Description of the Related Art

Electric motors for vehicles comprise a stator and a rotor as power-generating components. Both of these component parts are assembled from laminations which are insulated from one another and stacked one upon the other and which form a lamination stack and are configured in each instance as an annulus having circumferential slots. Conductors, generally copper wires or conductor bundles, are wound around the slots to form windings of a coil.

Wave winding is one possibility for winding these lamination stacks. To this end, winding mats are usually provided which are inserted into the slots and subsequently contacted. Alternatively, a direct winding around a lamination stack is also possible. In this regard, it is important that all of the elements of the electric motor be insulated from one another, for example, by films or paper. Lastly, the slots are sealed with slot liners and potted with a casting medium for better durability and insulation.

In wave winding, a conductor is guided through a slot, spans a fixed number of slots and is guided through a further slot. The area of the conductor spanning the plurality of slots is referred to as a winding head. The power-generating component of the electric machine or electric motor is wrapped in its entirety in this way with a plurality of conductors in a plurality of layers. The layer of the conductor is the radial position of the conductor within the respective slot. To maximize efficiency, smooth running and robustness, it is necessary to selectively adapt the path of the individual conductors to one another. In this regard, it is also necessary, inter alia, that the individual conductors change with respect to layer in a slot jump.

DE 10 2014 223 202 A1 discloses a wave winding for a stator in which the wave winding has at least two conductors for one respective phase of the machine which are interconnected in parallel and/or in series and are arrangeable at a given winding pitch in a number of at least two successive stator slots of each magnetic pole and each phase of the machine in a sequence predefined for each phase and for one respective magnetic pole along the circumference of the machine. The predefined sequence of interconnected conductors is swapped in at least one position along the circumference of the machine by at least one slot jump change which is defined in DE 10 2014 223 202 A1 as a groove skip. The winding heads of the conductor are formed in a curved manner and rotated once around their axis. The problem here is that the conductors, which have a rectangular cross section, build up at this location as a result of this rotation. Thus, particularly during slot jump changes, the conductors are no longer neatly guided, which reduces the efficiency and smooth running of the electric motor. This is particularly problematic in electric machines with a hole number of q=3 in which every phase has three conductors which run directly in adjacent slots because, in this case, the conductors are guided especially closely.

### SUMMARY OF THE INVENTION

It is an object of one aspect of the invention to provide a power-generating component for an electric motor with a hole number of q=3 which has a comparatively improved efficiency and smoother running.

The power-generating component of an electric machine described in the introductory part has at least one slot jump change provided within every revolution of the composite conductor. This higher number of slot jump changes compared with the prior art enables a smoother running and an improved efficiency, since a high electromagnetic symmetry is achieved in this way.

In an advantageous configuration, the first conductor, the second conductor and the third conductor, respectively, comprise a curved winding head which has an S-shaped twist at its apex. Conductors with a rectangular cross-section are most often used to achieve the highest possible packing density within the individual slots. This prevents the twisting of the conductor which was known heretofore from the prior art and which leads to a higher space requirement and impedes a denser arrangement in the area of the slot jumps.

To arrange the conductors as densely as possible, it is advantageous when the winding heads of at least two conductors of the first conductor, second conductor and third conductor are arranged in parallel one above the other or adjacent to one another. The remaining conductor is then guided above or below the two other conductors. It is particularly advantageous when the winding heads of the first conductor, second conductor and third conductor are arranged parallel to one another one above the other. Electric machines with particularly favorable characteristics can be produced in this way. This is achieved particularly in that the S-shaped twist is less bulky compared to sword winding and thus enables a denser arrangement of the conductors.

In a further advantageous configuration, the slot jump changes are arranged radially adjacent to one another at the lamination stack. This makes it possible to arrange the conductors as close together as possible also in the area of the slot jump changes and to optimize the power characteristics and running characteristics of an electric machine outfitted with such a power-generating component.

In a further advantageous configuration, the wave winding has a fractional pitch or chording by which the first conductor, the second conductor and the third conductor are collectively arranged offset by at least one slot compared with a preceding layer. This is achieved by a suitably executed slot jump and slot jump change in which the composite conductor is offset by at least one slot in the center compared with a preceding layer.

It is further advantageous when the wave winding has a plurality of phases comprising one or more composite conductors in each instance. This improves the efficiency of the electric motor in that the phases can be connected one after the other. Any slot jump changes in the individual phases are ideally arranged adjacently because this is advantageous for the smooth running and efficiency of the electric motor.

The above-stated object is also met through a wave winding, already described, for insertion in a power-generating component of an electric machine. This can be directly inserted into the rotor or stator in the form of a winding mat.

It will be understood that the features mentioned above and those yet to be explained below may be used not only in the stated combinations but also in other combinations or alone without departing from the scope of the present invention.

### BRIEF DESCRIPTION OF THE DRAWINGS

The invention will be explained in more detail in the following by embodiment examples with reference to the accompanying drawings which also disclose key features of the invention. These embodiment examples are provided merely to be illustrative and should not be considered as restrictive. For example, a description of an embodiment example having a plurality of elements or components should not be interpreted to mean that all of these elements or components are necessary for its implementation. On the contrary, other embodiment examples may also contain alternative elements and components, fewer elements or components, or additional elements or components. Elements or components of different embodiment examples can be combined with one another unless otherwise stated. Modifications and alterations which are described for one of the embodiment examples may also be applicable to other embodiment examples. Like or comparable elements in the various figures are designated by the same reference numerals and not mentioned repeatedly so as to avoid repetition. The drawings show:

FIG. 1 is a stator with a conductor;

FIG. 2 is a schematic diagram of a winding scheme; and

FIG. 3 is a schematic diagram of a further winding scheme.

### DETAILED DESCRIPTION OF THE PRESENTLY PREFERRED EMBODIMENTS

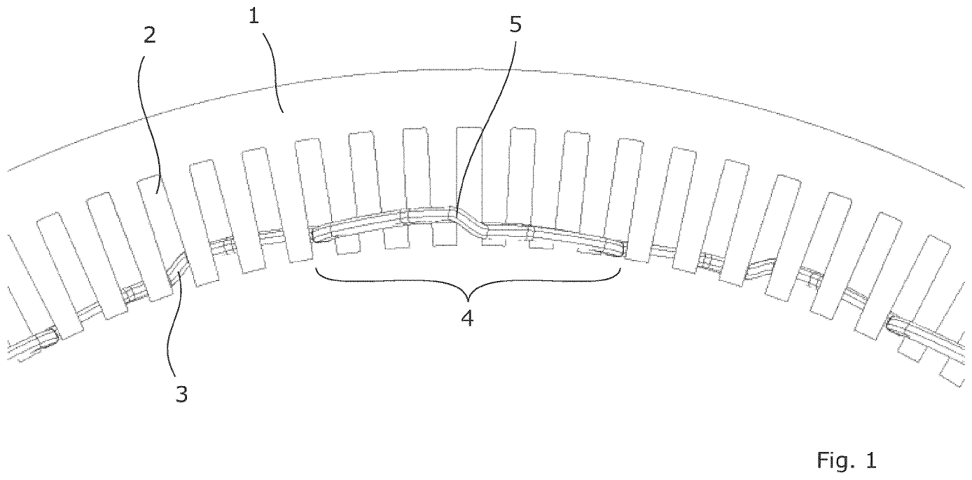

FIG. 1 shows a lamination stack 1 of a stator as a power-generating component with a plurality of slots 2 through which a conductor 3 runs. This conductor 3 is guided through a first slot 2, passes into a winding head 4 which spans a first number of slots 2 and is guided through a second slot 2 on the opposite side of the lamination stack 1, where there is a further winding head 4. In this way, the conductor 3 is guided in a plurality of revolutions around the stator. The winding head 4 is curved and, in this embodiment, spans exactly six slots 2. It has an S-shaped twist 5 at its apex so that adjacent conductors 3, not shown, can be arranged close beside conductor 3. In particular, the conductor 3, which has a rectangular cross section, is not rotated once around its own axis in the area of the winding head 4. Further, there is a layer change at the winding head 4, which corresponds to a change of the radial position of the conductor 3 within the slots 2. This is brought about by the S-shaped twist 5.

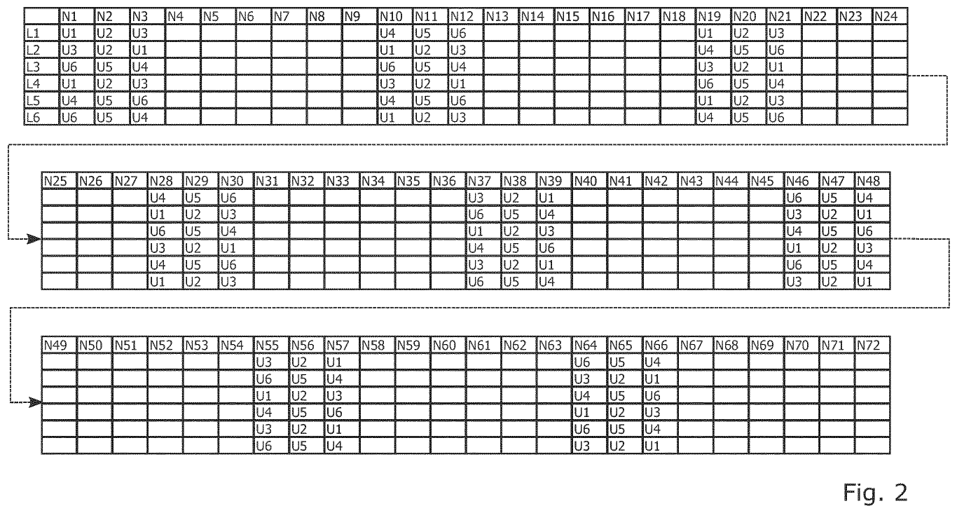

FIG. 2 shows a schematic diagram of a winding scheme for a wave winding of the lamination stack 1 which has exactly seventy-two slots N1, . . . , N72. The first row indicates the numbering for the exact designation of the slots N1, . . . , N72. The first column indicates a layer L1, . . . , L6 within a slot N1, . . . , N72. Layer L1 is a position at a base of the respective slot N1, . . . , N72, and the distance from the base increases as the reference number increases. Accordingly, the path of each conductor 3 through the slots N1, . . . , N72 of the lamination stack 1 can be exactly tracked, and it has a winding head 4 spanning a number of slots N1, . . . , N72 always alternating from a first side to a second side of the lamination stack 1.

All of the conductors 3 for a phase are entered in the winding scheme, and the winding of a first conductor U1, a second conductor U2, a third conductor U3, a fourth conductor U4, a fifth conductor U5 and a sixth conductor U6 is described. The first conductor U1, second conductor U2 and third conductor U3 form a first composite conductor, the fourth conductor U4, fifth conductor U5 and sixth conductor U6 form a second composite conductor, all of the conductors U1, U2, U3, U4, U5, U6 are connected in series or in parallel and accordingly form a common phase. For ease of comprehension, the slots N1, . . . , N72 spanned by the six conductors U1, U2, U3, U4, U5, U6 have not been entered. Conductors 3 which are associated with one or more phases individually or in one or more composite conductors are also guided into these slots N1, . . . , N72. Their arrangement can correspond to, or also deviate from, that of the first and second composite conductors. Since the winding of the lamination stack 1 should be carried out uniformly, two further phases, each with six conductors 3, are added in this case. This results in a winding with three phases, a hole number of q =3 and, in this case, a pole pair number of p=4.

The first conductor U1, second conductor U2 and third conductor U3 start on the first side of the lamination stack 1 and are guided through the first three adjacent slots N1, N2 and N3, respectively. They exit on a second side of the lamination stack 1 and span eight of the slots N1 to N72 in each instance in a slot jump in which the winding heads 4 of the first conductor U1, second conductor U2 and third conductor U3 run in parallel, such that they are guided through the adjacent slots N10, N11 and N12, respectively, to the first side of lamination stack 1. During the slot jump, a layer change from layer L1 to layer L2 is also carried out. On the first side, a further slot jump is then carried out with a further layer change. This is continued until all seventy-two slots N1, . . . , N72 have been passed through or spanned in this manner so that a revolution is carried out and the pattern starting in the first three slots N1, N2 and N3 is continued into the next layers, in this case, L3 and L4. Accordingly, the power-generating component has three revolutions in six layers L1, . . . , L6. However, this quantity is generally freely selectable and depends on the size of the component so that there is a large number of revolutions.

A first slot jump change in which the first conductor U1, second conductor U2 and third conductor U3 span a different number of slots N1, . . . , N72 from one another is carried out between the twenty-eighth slot N28 and the thirty-ninth slot N39 in the first revolution. The winding head 4 of the first conductor U1 in this case runs from the twenty-eighth slot N28 to the thirty-ninth slot N39 and that of the second conductor U2 spans an identical number of slots N1, . . . , N72 compared with the slot jump, i.e., in this case, from the twenty-ninth slot N29 to the thirty-eighth slot N38, and the winding head 4 of the third conductor U3 runs from the thirtieth slot N30 to the thirty-seventh slot N37. The arrangement of the first conductor U1, second conductor U2 and third conductor U3 within the composite conductor is accordingly swapped. Exactly one revolution later, there is a second slot jump change such that the first conductor U1, second conductor U2 and third conductor U3 once again change their position in the composite conductor and are again located in the original arrangement. The arrangement of conductors U1, U2, U3 relative to one another in the composite conductor is usually adapted to the specific configuration and the desired characteristics of the electric machine. Accordingly, conductors U1, U2, U3 can be swapped cyclically, by pairs or in some other way. It is also possible to introduce with the second slot jump change an arrangement of conductors U1, U2, U3 diverging from the initial position and, for example, to first restore the original arrangement not until the third slot jump change. Alternatively, a further, diverging arrangement can also be selected in the third slot jump change.

In FIG. 2, it is advisable to arrange the winding heads 4 of the first conductor U1, second conductor U2 and third conductor U3 parallel to one another and one above the other particularly in the region of the slot jump change. This is made possible by the S-shaped twist 5 because, in contrast to sword winding, conductors U1, U2, U3 are not twisted and can accordingly be situated or stacked closer together. The winding scheme is continued in the described manner until the sixth layer L6 is completed.

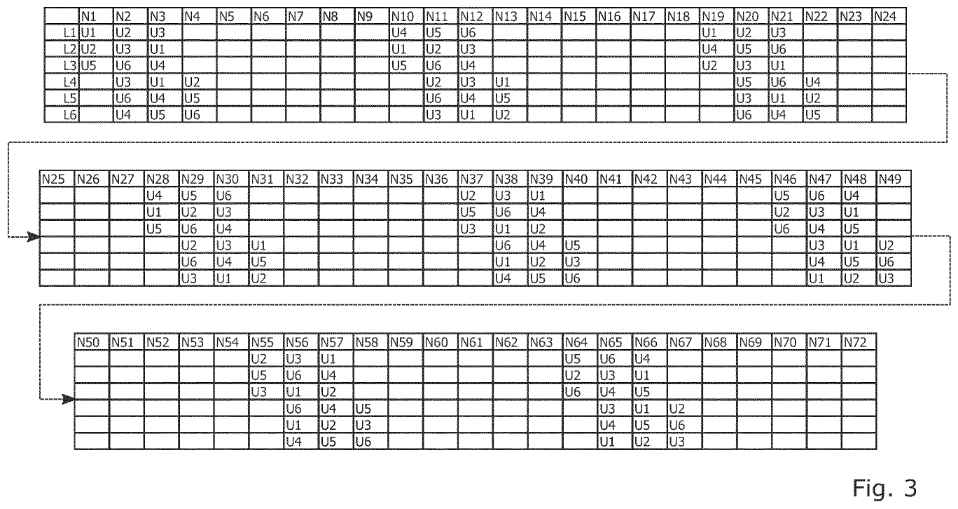

An alternative winding scheme for a wave winding is shown in FIG. 3. The slot jumps of the first revolution are identical to those in FIG. 2. However, the slot jump changes are carried out differently. Accordingly, in the first revolution, a first slot jump change is carried out between the twenty-eighth slot N28 and the thirty-ninth slot N39 in which the first conductor U1, second conductor U2 and third conductor U3 span a different number of slots N1, . . . , N72 from one another. The winding head 4 of the first conductor U1 runs in this case from the twenty-eighth slot N28 to the thirty-ninth slot N39, that of the second conductor U2 spans one less slot N1, . . . , N72 compared with the slot jump, i.e., in this case, from the twenty-ninth slot N29 to the thirty-seventh slot N37, and the winding head 4 of the third conductor U3 runs from the thirtieth slot N30 to the thirty-eighth slot N38. Accordingly, the arrangement of the first conductor U1, second conductor U2 and third conductor U3 within the composite conductor is swapped. Exactly one revolution later, there is a second slot jump change such that the first conductor U1, second conductor U2 and third conductor U3 once again change their position in the composite conductor. After a third slot jump change which takes place one revolution after the second slot jump change, the three conductors U1, U2, U3 in this embodiment example are again located in their initial position within the composite conductor. Accordingly, in this case, the first conductor U1, second conductor U2 and third conductor U3 are swapped cyclically with each slot jump change. Ideally, the winding heads 4 are arranged in such a way that the conductor 3 that is arranged as the first conductor 3 in the composite conductor runs above the other two conductors 3 which are arranged in parallel adjacent to one another. Based on the example of the first slot jump, this means that the first conductor U1 runs above the second conductor U2 and third conductor U3, while the second conductor U2 and the third conductor U3 are arranged in parallel adjacent to one another.

The first conductor U1, second conductor U2 and third conductor U3 are offset relative to one another in their second revolution in that the slot jumps are alternately formed one slot N1, . . . , N72 longer or one slot N1, . . . , N72 shorter. Consequently, the composite conductor is arranged between the third layer L3 and fourth layer LA so as to be offset by one slot N1, . . . , N72 in each instance. A slot jump change also takes place here, in this case between the twenty-eighth slot N28 and fortieth slot N40, since the difference in the width of the slot jumps must be taken into account in this case. The third revolution is carried out again with slot jumps spanning eight slots N1, . . . , N72, while the first conductor U1, second conductor U2 and third conductor U3 are collectively arranged to be offset by one slot N1, . . . , N72 compared with the first two preceding layers L1, L2. The acoustic characteristics of an electric machine outfitted with a power-generating component that is wound in this manner are improved as a result of this offset, referred to as chording, which can also be an offset by more than one slot N1, . . . , N72.

In addition to the first composite conductor, the power-generating component in both embodiment examples comprises the second composite conductor which comprises the fourth conductor U4, fifth conductor U5 and sixth conductor U6. The latter run in opposite direction to the first composite conductor: while the slot jump of the first composite conductor takes place on the first side of the lamination stack 1, the slot jump of the second composite conductor is located on the opposite, second side. Accordingly, in both embodiment examples, the power-generating component which is wound to completion with the two composite conductors has two slot jump changes in every revolution which are located at the same slots N1, . . . , N72 or at least adjacent slots N1, . . . , N72. Accordingly, all of the slot jump changes are arranged at the lamination stack 1 radially adjacent to one another. This can also include the phases that have not been entered, the winding of which can be carried out analogously to that of the first to sixth conductors U1, . . . , U6. It is also easily possible to apply the principles presented subsequently to electric machines of divergent construction, number of phases, number of holes, number of pole pairs and therefore also a divergent number of slots N1, . . . , N72.

Thus, while there have shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-8. (canceled)

9. A power-generating component of an electric machine, comprising:
an annular lamination stack with a plurality of radially arranged slots; and
a wave winding with at least a first continuous conductor, a second continuous conductor, and a third continuous conductor which are each guided in a plurality of revolutions through adjacent slots and which are connected in parallel or in series and form a composite conductor,
wherein the composite conductor has a plurality of slot jumps in which the first conductor, the second conductor, and the third conductor, respectively, span an equal number of slots and in which there is a layer change, and
wherein the composite conductor has at least one slot jump change in which the first conductor, the second conductor, and the third conductor span a different number of slots from one another such that an arrangement of the first conductor, the second conductor, and the third conductor relative to one another is swapped after the slot jump change,
wherein at least one slot jump change is provided within every revolution of the composite conductor.

10. The power-generating component according to claim 9, wherein the first conductor, the second conductor, and the third conductor, respectively, comprise a curved winding head which has an S-shaped twist at its apex.

11. The power-generating component according to claim 10, wherein the winding heads of at least two conductors of the first conductor, second conductor, and third conductor are arranged in parallel one above the other or adjacent to one another.

12. The power-generating component according to claim 11, wherein the winding heads of the first conductor, second conductor, and third conductor are arranged parallel to one another one above the other.

13. The power-generating component according to claim 9, wherein the slot jump changes are arranged radially adjacent to one another at the lamination stack.

14. The power-generating component according to claim 9, wherein the wave winding is chorded such that the first conductor, the second conductor, and the third conductor are collectively arranged to be offset by at least one slot compared with a preceding layer.

15. The power-generating component according to claim 9, wherein the wave winding has a plurality of phases comprising one or more composite conductors in each instance.

16. A wave winding for insertion in a power-generating component of an electric machine, comprising:
an annular lamination stack with a plurality of radially arranged slots; and
a wave winding with at least a first continuous conductor, a second continuous conductor, and a third continuous conductor which are each guided in a plurality of revolutions through adjacent slots and which are connected in parallel or in series and form a composite conductor,
wherein the composite conductor has a plurality of slot jumps in which the first conductor, the second conductor, and the third conductor, respectively, span an equal number of slots and in which there is a layer change, and
wherein the composite conductor has at least one slot jump change in which the first conductor, the second conductor, and the third conductor span a different number of slots from one another such that an arrangement of the first conductor, the second conductor, and the third conductor relative to one another is swapped after the slot jump change,
wherein at least one slot jump change is provided within every revolution of the composite conductor.
